(19) United States
(12) Patent Application Publication
(10) Pub. No.: US 2026/0210316 A1
(43) Pub. Date: Jul. 23, 2026

(54) INTERNAL COMBUSTION ENGINE SYSTEM AND COMPRESSOR

(71) Applicant: KAWASAKI MOTORS, LTD., Akashi-shi, Hyogo (JP)

(72) Inventors: Kyohei IZUMI, Akashi-shi (JP); Hiromitsu KIYOSE, Kobe-shi (JP); Yutaka SUZUKI, Kobe-shi (JP); Tomohide HATTORI, Kobe-shi (JP); Makoto NINOMIYA, Kobe-shi (JP)

(21) Appl. No.: 19/497,450

(22) PCT Filed: Dec. 22, 2023
(86) PCT No.: PCT/JP2023/046164

§ 371 Date: Dec. 26, 2025

(30) Foreign Application Priority Data
Jun. 30, 2023 (JP) 2023-108691

(51) Int. Cl. F02M 21/02

(52) U.S. Cl. CPC F02M 21/0245; F02M 21/0206; F02M 21/0242; F02M 2700/05

(57) ABSTRACT

An internal combustion engine system includes: a fuel gas passage that connects a fuel storing source to an internal combustion engine, the fuel storing source storing a fuel gas in a compressed state; and a compressor that pressurizes the fuel gas in the fuel gas passage. The compressor includes at least one reciprocating structure, and the reciprocating structure includes: a cylinder including a suction port and a discharge port; a piston accommodated in the cylinder and defining a compression chamber facing the suction port and the discharge port; a rod projecting from the piston; and a cam that reciprocates the rod.

### TECHNICAL FIELD

The present disclosure relates to an internal combustion engine system and a compressor.

### BACKGROUND ART

PTL 1 discloses an internal combustion engine system that generates driving force in such a manner that an internal combustion engine combusts, as fuel, a hydrogen gas supplied from a high-pressure hydrogen gas tank through a pressure reducing valve.

### CITATION LIST

### Patent Literature

PTL 1: Japanese Laid-Open Patent Application Publication No. 2021-173182

### SUMMARY OF INVENTION

### Technical Problem

When a fuel gas in a fuel tank is continuously consumed by the operation of an internal combustion engine, the internal pressure of the fuel tank eventually drops to less than a predetermined value. In this state, the fuel gas in the fuel tank cannot be appropriately supplied to the internal combustion engine. Thus, although the fuel gas remains in the fuel tank, the fuel tank is regarded as empty.

An object of one aspect of the present disclosure is to increase the amount of fuel gas that can be supplied to the internal combustion engine while preventing an increase in the size of the system.

### Solution to Problem

An internal combustion engine system according to one aspect of the present disclosure includes: a fuel gas passage that connects a fuel storing source to an internal combustion engine, the fuel storing source storing a fuel gas in a compressed state; and a compressor that pressurizes the fuel gas in the fuel gas passage. The compressor includes at least one reciprocating structure, and the reciprocating structure includes: a cylinder including a suction port and a discharge port; a piston accommodated in the cylinder and defining a compression chamber facing the suction port and the discharge port; a rod projecting from the piston; and a cam that reciprocates the rod.

A compressor according to one aspect of the present disclosure includes: a cylinder including a suction port and a discharge port; a piston accommodated in the cylinder and defining a compression chamber facing the suction port and the discharge port; a rod projecting from the piston; a cam that reciprocates the rod; a camshaft that rotates the cam; and a ring that covers an outer peripheral surface of the cam and is rotatable relative to the cam. The outer peripheral surface of the cam includes a true circular shape. The camshaft is eccentrically connected to the cam. The cam pushes the rod through the ring.

A compressor according to another aspect of the present disclosure includes: a cylinder including a suction port and a discharge port; a piston accommodated in the cylinder and defining a compression chamber facing the suction port and the discharge port; a rod projecting from the piston; a first rod seal located between an outer peripheral surface of the rod and an inner peripheral surface of the cylinder; and a recompression chamber located between the piston and the first rod seal in an axial direction of the cylinder. The recompression chamber is defined by the outer peripheral surface of the rod and the inner peripheral surface of the cylinder. A volume of the recompression chamber decreases by backward movement of the piston. The cylinder includes an outflow port that is in fluid communication with the recompression chamber.

### Advantageous Effects of Invention

According to the internal combustion engine system of one aspect of the present disclosure, the amount of fuel gas that can be supplied to the internal combustion engine can be increased while preventing an increase in the size of the system. The compressor according to one aspect of the present disclosure can be made smaller than a reciprocating compressor in which a piston is caused to reciprocate by a crankshaft and a connecting rod. The compressor according to another aspect of the present disclosure can prevent the leaked fuel gas from accumulating in the cylinder.

### BRIEF DESCRIPTION OF DRAWINGS

FIG. 1 is a schematic diagram showing a movable body on which an internal combustion engine system according to an embodiment is mounted.

FIG. 2 is an enlarged schematic diagram showing a compressor assembly of FIG. 1. FIG. 3 is a perspective view showing a compressor of FIG. 2.

FIG. 4 is a vertical sectional view showing the compressor of FIG. 3.

FIG. 5 is a sectional view taken along line V-V of FIG. 4.

FIG. 6 is a horizontal sectional view showing a recompression chamber and a re-leak chamber of the compressor of FIG. 5.

FIG. 7 is a block diagram showing an example of the arrangement of a speed reducer and an electric motor.

FIG. 8 is a block diagram showing another example of the arrangement of the speed reducer and the electric motor.

### DESCRIPTION OF EMBODIMENTS

Hereinafter, an embodiment will be described with reference to the drawings.

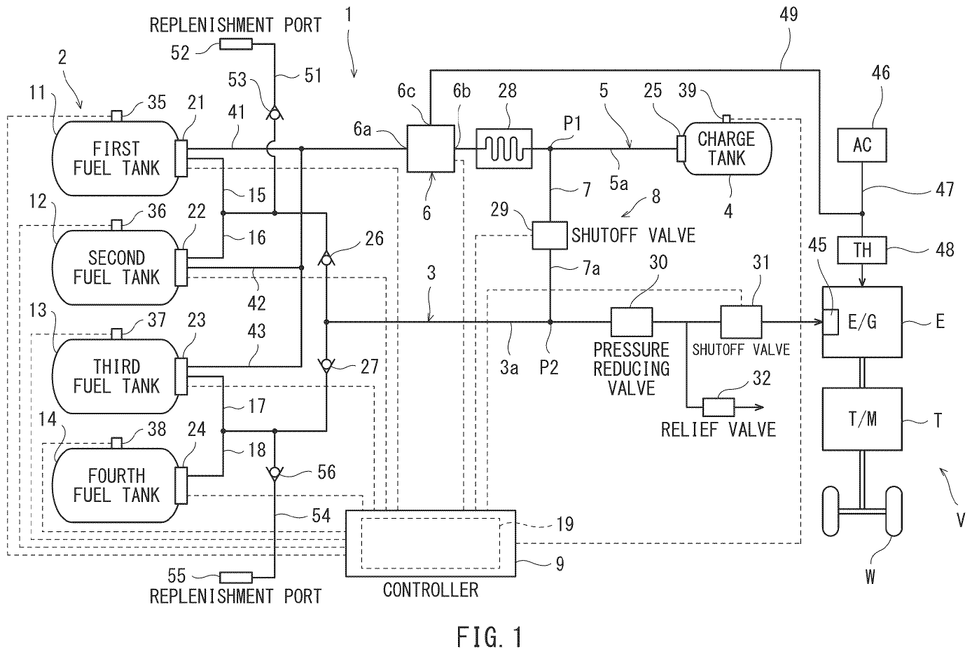

FIG. 1 is a schematic diagram showing a movable body on which an internal combustion engine system according to the embodiment is mounted. As shown in FIG. 1, in the present embodiment, an internal combustion engine system 1 is mounted on a movable body V. The movable body V may be a manned vehicle or an unmanned vehicle. The movable body V is, for example, a wheeled vehicle including a driving wheel W. In the movable body V, driving force generated by an internal combustion engine E of the internal combustion engine system 1 is transmitted to the driving wheel W through a transmission T. The movable body V may be, for example, a two-wheeled vehicle, a three-wheeled vehicle, a four-wheeled vehicle, a railcar, or the like. The driving wheel W is one example of a propulsive force generator that generates propulsive force by the driving force generated by the internal combustion engine E of the internal combustion engine system 1. The movable body V may be a water vehicle, an aircraft, or the like. In this case, the propulsive force generator may be a propeller or a fan.

The internal combustion engine system 1 includes a fuel storing source 2. The fuel storing source 2 stores a fuel gas in a compressed state. The fuel storing source 2 includes fuel tanks. As one example, the fuel storing source 2 includes a first fuel tank 11, a second fuel tank 12, a third fuel tank 13, and a fourth fuel tank 14. These fuel tanks 11 to 14 store the fuel gas in a compressed state. The internal pressure of each of the fuel tanks 11 to 14 in a full state is higher than standard atmospheric pressure (0.1 MPa). Specifically, the internal pressure is adequately higher than fuel injection pressure required by the internal combustion engine E. The internal pressure of each of the fuel tanks 11 to 14 in a full state is, for example, 70 MPa. The fuel gas is, for example, a hydrogen gas. To obtain the same output from the internal combustion engine E, the amount of hydrogen gas required is larger than the amount of carbon-based fuel required. Therefore, the amount of fuel gas remaining in the fuel tanks 11 to 14 tends to decrease quickly. The fuel gas may contain vaporized fuel in a tank stored state and may be a different type of fuel gas, such as hydrocarbon fuel.

The internal combustion engine system 1 includes the internal combustion engine E. The internal combustion engine E combusts the fuel gas supplied from the fuel storing source 2, converts this combustion energy into rotational energy, and outputs the rotational energy as the driving force. The internal combustion engine E is, for example, a direct injection engine. In the present embodiment, the internal combustion engine E is a reciprocating engine. In this case, in the internal combustion engine E, the fuel gas is exploded in a cylinder, and the reciprocating movement of a piston is performed by the expansion of the gas in the cylinder. The reciprocating movement of the piston is converted into the rotational movement of a crankshaft of the internal combustion engine E and is output.

The internal combustion engine E includes a fuel injector 45. The internal combustion engine E needs to be supplied with the fuel gas having predetermined fuel injection pressure higher than the standard atmospheric pressure (0.1 MPa). Required pressure of the fuel gas supplied to the direct injection engine is higher than required pressure of the fuel gas supplied to a non-direct injection engine. In the direct injection engine, when the gas in a combustion chamber in the cylinder becomes a compressed state by the piston, the fuel gas is directly supplied into the combustion chamber. When the direct injection engine is used as the internal combustion engine E, the internal combustion engine E needs to be supplied with the fuel gas having pressure of, for example, 10 MPa or more from the fuel storing source 2.

Therefore, when a flow passage extending from the fuel storing source to the fuel injector of the internal combustion engine has a simple configuration, and the pressure of the fuel gas in the fuel storing source becomes less than 10 MPa, the fuel gas cannot be injected from the fuel injector in the internal combustion engine, and the fuel storing source is regarded as empty. To be specific, when the flow passage extending from the fuel storing source to the fuel injector of the internal combustion engine has a simple configuration, a large amount of fuel gas remains in the fuel storing source when the fuel storing source is regarded as empty. However, according to the internal combustion engine system 1 of the present embodiment, as described below, the fuel gas in the fuel storing source 2 is utilized as much as possible for supply to the internal combustion engine E. Therefore, a smaller amount of fuel gas remains in the fuel storing source 2 when the fuel storing source 2 is regarded as empty, and thus, the fuel gas in the fuel storing source 2 is efficiently utilized.

An intake passage 47 is connected to an intake port of the internal combustion engine E. A throttle valve 48 is interposed in the intake passage 47. Outside air purified by an air cleaner 46 flows through the intake passage 47, is supplied to the intake port of the internal combustion engine E, and is used for combustion. The amount of intake air supplied to the internal combustion engine E is adjusted by the throttle valve 48.

The internal combustion engine system 1 includes a main passage 3 that connects the fuel storing source 2 to the internal combustion engine E. Specifically, the main passage 3 includes a first main passage 15, a second main passage 16, a third main passage 17, and a fourth main passage 18. The first main passage 15 connects the first fuel tank 11 to the internal combustion engine E. The second main passage 16 connects the second fuel tank 12 to the internal combustion engine E. The third main passage 17 connects the third fuel tank 13 to the internal combustion engine E. The fourth main passage 18 connects the fourth fuel tank 14 to the internal combustion engine E. In the present embodiment, the first to fourth main passages 15 to 18 merge with each other on the way to the internal combustion engine E. To be specific, the main passage 3 includes a common passage portion 3a that integrates downstream portions of the first to fourth main passages 15 to 18 and is connected to the internal combustion engine E.

The internal combustion engine system 1 includes a charge tank 4. The volume of the charge tank 4 is not especially limited. In the present embodiment, the volume of the charge tank 4 is smaller than each of the volumes of the fuel tanks 11 to 14. A maximum allowable internal pressure of the charge tank 4 is lower than each of maximum allowable internal pressures of the fuel tanks 11 to 14. The maximum allowable internal pressure of the charge tank 4 may be the same as or higher than each of the maximum allowable internal pressures of the fuel tanks 11 to 14.

The internal combustion engine system 1 includes a charge passage 5. The charge passage 5 includes a first charge passage 41, a second charge passage 42, and a third charge passage 43. The first charge passage 41 connects the first fuel tank 11 to the charge tank 4. The second charge passage 42 connects the second fuel tank 12 to the charge tank 4. The third charge passage 43 connects the third fuel tank 13 to the charge tank 4. The fourth fuel tank 14 is not connected to the charge tank 4.

In the present embodiment, downstream portions of the first to third charge passages 41 to 43 are integrated with each other. The first to third charge passages 41 to 43 merge with each other on the way to the charge tank 4. To be specific, the charge passage 5 includes a common passage portion 5a that integrates the downstream portions of the first to third charge passages 41 to 43 and is connected to the charge tank 4. A compressor assembly 6 is interposed in the common passage portion 5a of the charge passage 5. The compressor assembly 6 pressurizes the fuel gas, flowing from the first to third fuel tanks 11 to 13 to the charge passage 5, toward the charge tank 4. The fuel gas pressurized by the compressor assembly 6 is temporarily stored in the charge tank 4.

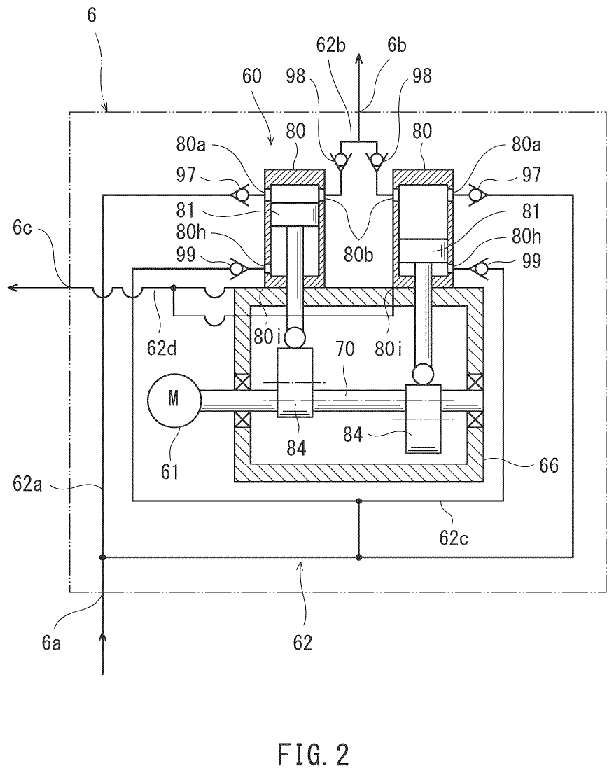

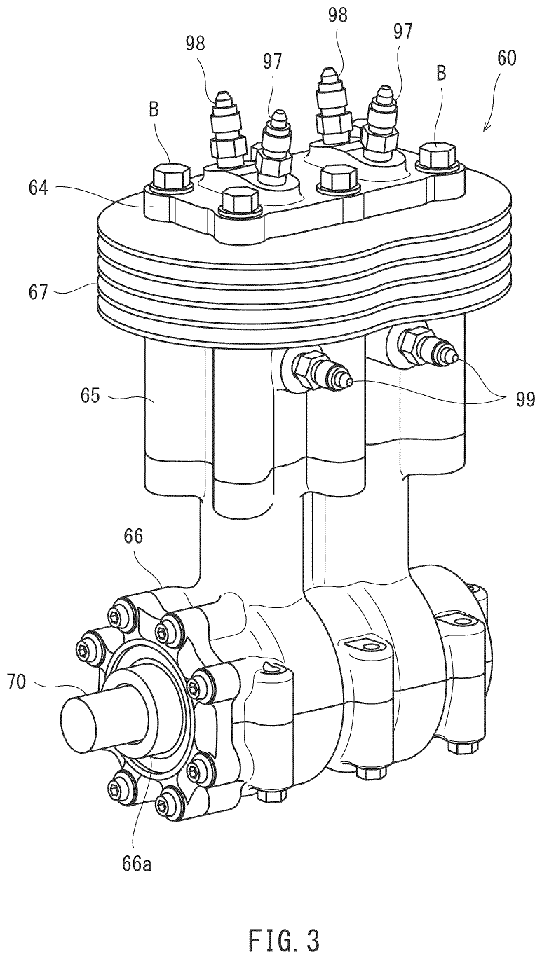

The compressor assembly 6 includes an inlet port 6a, an outlet port 6b, and a leak port 6c. The inlet port 6a is a port into which the fuel gas flows from an upstream portion of the common passage portion 5a of the charge passage 5. The outlet port 6b is a port through which the fuel gas pressurized by the compressor assembly 6 is discharged to a downstream portion of the common passage portion 5a of the charge passage 5. The leak port 6c is a port through which a blow-by gas generated by a below-described compressor 60 (see FIG. 2) of the compressor assembly 6 is discharged. The leak port 6c is connected to the intake passage 47 through a blow-by gas passage 49.

A cooler 28 is interposed in the common passage portion 5a of the charge passage 5. The cooler 28 cools the fuel gas discharged from the outlet port 6b of the compressor assembly 6. To be specific, the fuel gas discharged from the outlet port 6b of the compressor assembly 6 is reduced in volume by being cooled by the cooler 28 and then is supplied to the charge tank 4.

The internal combustion engine system 1 includes a sub-passage 7. The sub-passage 7 connects the charge tank 4 to the internal combustion engine E. Specifically, the sub-passage 7 includes a bridge passage 7a that connects the common passage portion 5a of the charge passage 5 to the common passage portion 3a of the main passage 3. A portion of the common passage portion 5a of the charge passage 5, which is located downstream of a merge point Pl between the bridge passage 7a and the common passage portion 5a of the charge passage 5, serves as part of the sub-passage 7. A portion of the common passage portion 3a of the main passage 3, which is located downstream of a merge point P2 between the bridge passage 7a and the common passage portion 3a of the main passage 3, serves as part of the sub-passage 7. The fuel gas in the charge tank 4 may be supplied to the internal combustion engine E through the portion of the common passage portion 5a of the charge passage 5 which is located downstream of the merge point P1, the bridge passage 7a, and the portion of the common passage portion 3a of the main passage 3 which is located downstream of the merge point P2.

The main passage 3, the charge passage 5, and the sub-passage 7 are fuel gas passages that connect the fuel storing source 2 to the internal combustion engine E. The internal combustion engine system 1 includes a valve system 8 located in the fuel gas passages. The valve system 8 opens and closes the main passage 3, the charge passage 5, and the sub-passage 7. The configuration of the valve system 8 is not limited to a specific type. To be specific, various types may be adopted as long as the valve system 8 can open and close the main passage 3, the charge passage 5, and the sub-passage 7.

For example, the valve system 8 includes a first fuel tank valve 21, a second fuel tank valve 22, a third fuel tank valve 23, a fourth fuel tank valve 24, a charge tank valve 25, check valves 26 and 27, shutoff valves 29 and 31, a pressure reducing valve 30, and a relief valve 32. The first to fourth fuel tank valves 21 to 24, the charge tank valve 25, and the shutoff valves 29 and 31 are, for example, electromagnetic valves that are electrically controllable.

The first fuel tank valve 21 operates between a closed state in which a port of the first fuel tank 11 is closed, a first open state in which the port of the first fuel tank 11 communicates with the first main passage 15 but does not communicate with the first charge passage 41, and a second open state in which the port of the first fuel tank 11 communicates with the first charge passage 41 but does not communicate with the first main passage 15.

The second fuel tank valve 22 operates between a closed state in which a port of the second fuel tank 12 is closed, a first open state in which the port of the second fuel tank 12 communicates with the second main passage 16 but does not communicate with the second charge passage 42, and a second open state in which the port of the second fuel tank 12 communicates with the second charge passage 42 but does not communicate with the second main passage 16.

The third fuel tank valve 23 operates between a closed state in which a port of the third fuel tank 13 is closed, a first open state in which the port of the third fuel tank 13 communicates with the third main passage 17 but does not communicate with the third charge passage 43, and a second open state in which the port of the third fuel tank 13 communicates with the third charge passage 43 but does not communicate with the third main passage 17.

The first to third fuel tank valves 21 to 23 may be, for example, three-way valves. The first fuel tank valve 21 may include an on-off valve that may allow the port of the first fuel tank 11 to communicate with the first main passage 15 and an on-off valve that may allow the port of the first fuel tank 11 to communicate with the first charge passage 41. Similarly, each of the second and third fuel tank valves 22 and 23 may include two on-off valves.

The fourth fuel tank valve 24 operates between a closed state in which a port of the fourth fuel tank 14 is closed and an open state in which the port of the fourth fuel tank 14 communicates with the fourth main passage 18. The charge tank valve 25 operates between a closed state in which a port of the charge tank 4 is closed and an open state in which the port of the charge tank 4 communicates with the charge passage 5.

The check valves 26 and 27 allow the flow in the main passage 3 toward the internal combustion engine E and block its opposite flow. Specifically, the check valve 26 allows the flow in the main passage 3 from the first fuel tank 11 and the second fuel tank 12 toward the internal combustion engine E and blocks the flow in the main passage 3 toward the first fuel tank 11 and the second fuel tank 12. The check valve 27 allows the flow in the main passage 3 from the third fuel tank 13 and the fourth fuel tank 14 toward the internal combustion engine E and blocks the flow in the main passage 3 toward the third fuel tank 13 and the fourth fuel tank 14.

The shutoff valve 29 opens and closes the bridge passage 7a of the sub-passage 7. To be specific, when the shutoff valve 29 opens, the fuel gas in the charge tank 4 may be supplied through the sub-passage 7 to the common passage portion 3a of the main passage 3.

The pressure reducing valve 30 is located in the common passage portion 3a of the main passage 3. Specifically, the pressure reducing valve 30 is located in a portion downstream of the merge point P2 between the bridge passage 7a of the sub-passage 7 and the common passage portion 3a of the main passage 3. The pressure reducing valve 30 reduces the pressure of the fuel gas in the main passage 3 to predetermined pressure suitable for the internal combustion engine E. The pressure reducing valve 30 maintains the pressure downstream of the pressure reducing valve 30 in the main passage 3 at predetermined fuel injection pressure (10 MPa, for example) of the internal combustion engine E. When the pressure of the downstream portion of an internal passage of the pressure reducing valve 30 becomes lower than the fuel injection pressure, the pressure reducing valve 30 opens a bypass passage that allows the upstream portion of the internal passage and the downstream portion to communicate with each other. When the pressure of the downstream portion exceeds the fuel injection pressure, the pressure reducing valve 30 closes the bypass passage. Thus, the pressure of the fuel gas flowing through the downstream side of the pressure reducing valve 30 is made lower than the pressure of the fuel gas flowing through the upstream side of the pressure reducing valve 30 such that the pressure of the fuel gas supplied from the main passage 3 to the internal combustion engine E is maintained at the predetermined fuel injection pressure.

The shutoff valve 31 opens and closes a portion of the common passage portion 3a of the main passage 3 which is located downstream of the pressure reducing valve 30. The shutoff valve 31 can block the supply of the fuel gas from the main passage 3 to the internal combustion engine E in an emergency, for example. The shutoff valve 31 is located in a portion of the main passage 3 which is located downstream of the pressure reducing valve 30. The relief valve 32 discharges the fuel gas in the common passage portion 3a of the main passage 3, when the pressure in a portion of the common passage portion 3a of the main passage 3 which is located between the pressure reducing valve 30 and the shutoff valve 31 exceeds predetermined relief pressure.

A first fuel tank pressure sensor 35 detects the pressure of the fuel gas stored in the first fuel tank 11. A second fuel tank pressure sensor 36 detects the pressure of the fuel gas stored in the second fuel tank 12. A third fuel tank pressure sensor 37 detects the pressure of the fuel gas stored in the third fuel tank 13. A fourth fuel tank pressure sensor 38 detects the pressure of the fuel gas stored in the fourth fuel tank 14. A charge tank pressure sensor 39 detects the pressure of the fuel gas stored in the charge tank 4.

The internal combustion engine system 1 includes a replenishment structure for replenishing the fuel gas in the first to fourth fuel tanks 11 to 14. In the replenishment structure, specifically, a first replenishment passage 51 is connected to a portion, located upstream of the check valve 26, of an integrated portion of the first main passage 15 and the second main passage 16. A replenishment port 52 is located at an end portion of the first replenishment passage 51. A check valve 53 is located in the first replenishment passage 51. The check valve 53 allows the flow from the replenishment port 52 to the first fuel tank 11 and the second fuel tank 12 and blocks its opposite flow.

A second replenishment passage 54 is connected to a portion, located upstream of the check valve 27, of an integrated portion of the third main passage 17 and the fourth main passage 18. A replenishment port 55 is located at an end portion of the second replenishment passage 54. A check valve 56 is located in the second replenishment passage 54. The check valve 56 allows the flow from the replenishment port 55 toward the third fuel tank 13 and the fourth fuel tank 14 and blocks its opposite flow. In the replenishment structure, the fuel gas may be supplied from a single replenishment port to the first to fourth fuel tanks 11 to 14, or replenishment ports may be located so as to correspond to the respective fuel tanks 11 to 14.

The internal combustion engine system 1 includes a controller 9. The controller 9 controls the valve system 8 and a below-described electric motor 61 based on detection signals of the sensors 35 to 39. The controller 9 includes processing circuitry 19. The controller 9 includes, for example, a processor, a system memory, and a storage memory. The processor includes, for example, a central processing unit (CPU). The system memory is, for example, a RAM. The storage memory may include a ROM. The storage memory may include a hard disk, a flash memory, or a combination thereof. The storage memory stores a program. A configuration in which the processor executes the program read into the system memory is one example of the processing circuitry 19.

The processing circuitry 19 controls the valve system 8 to supply the fuel gas in at least one of the fuel tanks 11 to 14 to the internal combustion engine E. The processing circuitry 19 controls the below-described electric motor 61 to pressurize the fuel gas in at least one of the fuel tanks 11 to 13 by the compressor assembly 6. The processing circuitry 19 controls the valve system 8 to supply the fuel gas in the charge tank 4 to the internal combustion engine E.

As above, even when the pressure of the fuel gas in the fuel storing source 2 drops, the fuel gas can be pressurized by the compressor assembly 6, and the pressurized fuel gas can be supplied to the internal combustion engine E. Therefore, the amount of fuel gas that can be supplied to the internal combustion engine E can be increased without increasing the size of the fuel storing source 2.

FIG. 2 is an enlarged schematic diagram showing the compressor assembly 6 of FIG. 1. As shown in FIG. 2, the compressor assembly 6 includes the compressor 60, the electric motor 61, and a passage group 62. The compressor 60 will be described later with reference to FIGS. 3 to 5. The electric motor 61 drives the compressor 60. The passage group 62 will be described after the details of the compressor 60 are described with reference to FIGS. 3 to 5. In the present embodiment, the compressor 60 is driven by the driving force of the electric motor 61 but may be driven by utilizing the energy generated by the internal combustion engine E.

FIG. 3 is a perspective view of the compressor 60 of FIG. 2. As shown in FIG. 3, the compressor 60 is a reciprocating pump compressor. The number of cylinders included in the compressor 60 is not particularly limited, but is set to two in the present embodiment. The compressor 60 includes a cylinder head 64, a cylinder block 65, and a cam case 66. The cylinder head 64, the cylinder block 65, and the cam case 66 are separate pieces and are fastened to each other by through bolts B. Each of the through bolts B is inserted through the cylinder head 64, the cylinder block 65, and the cam case 66 in order.

The cylinder head 64 and the cylinder block 65 are made of a different material from the cam case 66. The cylinder head 64 and the cylinder block 65 are made of a metal material that is less susceptible to embrittlement by the fuel gas than the cam case 66. For example, when the fuel gas is a hydrogen gas, the cylinder head 64 and the cylinder block 65 are made of stainless steel. The cam case 66 is made of an aluminum alloy. In other words, the cylinder block 65 and the cylinder head 64 which are subjected to high-pressure hydrogen are made of a material having higher hydrogen embrittlement resistance than the cam case 66. Thus, when the fuel gas is hydrogen, the strength degradation of the compressor 60 by hydrogen is prevented, and the degree of freedom of the selection of the material of the cam case 66 increases. For example, when the aluminum alloy is used as the material of the cam case 66, the weight and manufacturing cost of the compressor 60 are reduced as a whole. The cylinder block 65 and the cylinder head 64 may be made of the same material as the cam case 66.

Radiating fins as a heat sink 67 are located at and are integrated with the cylinder block 65. The cam case 66 includes an axial through hole 66a. A camshaft 70 accommodated in the cam case 66 extends through the axial through hole 66a and projects to the outside. The driving force of the electric motor 61 (see FIG. 2) is input to an end portion of the camshaft 70 projecting from the cam case 66 to the outside.

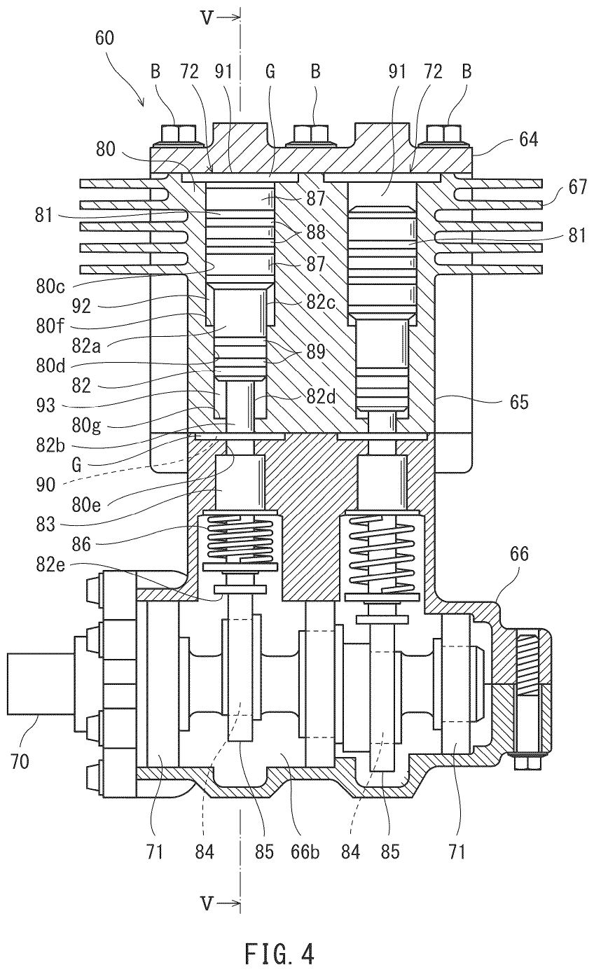

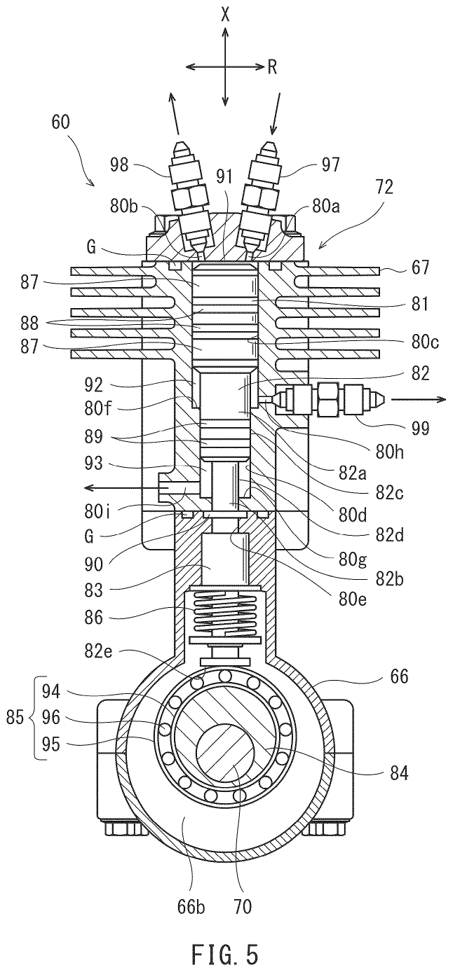

FIG. 4 is a vertical sectional view showing the compressor 60 of FIG. 3. FIG. 5 is a sectional view taken along line V-V of FIG. 4. As shown in FIGS. 4 and 5, the compressor 60 is a reciprocating pump including two cylinders. To be specific, the compressor 60 includes two reciprocating structures 72. Each of the two reciprocating structures 72 includes a cylinder 80, a piston 81, a rod 82, a linear bushing 83, a cam 84, a cam bearing 85, a spring 86, a rider ring or rider rings 87, a piston seal or piston seals 88, a first rod seal or first rod seals 89, a second rod seal 90, a compression chamber 91, a recompression chamber 92, and a re-leak chamber 93.

The cylinder 80 includes a suction port 80a and a discharge port 80b. The suction port 80a is connected to the inlet port 6a (see FIG. 2) of the compressor assembly 6. The discharge port 80b is connected to the outlet port 6b (see FIG. 2) of the compressor assembly 6. A check valve 97 that communicates with the suction port 80a is attached to the cylinder 80. A check valve 98 that communicates with the discharge port 80b is attached to the cylinder 80.

The check valve 97 allows the flow from the inlet port 6a (see FIG. 2) of the compressor assembly 6 through the suction port 80a to the compression chamber 91 and blocks the flow from the compression chamber 91 through the suction port 80a to the inlet port 6a (see FIG. 2) of the compressor assembly 6. The check valve 98 allows the flow from the compression chamber 91 through the discharge port 80b to the outlet port 6b (see FIG. 2) of the compressor assembly 6 and blocks the flow from the outlet port 6b (see FIG. 2) of the compressor assembly 6 through the discharge port 80b to the compression chamber 91.

The cylinder 80 includes a first inner peripheral surface 80c, a second inner peripheral surface 80d, and a third inner peripheral surface 80e. To be specific, an inner peripheral surface of the cylinder 80 includes steps lined up in a reciprocating direction of the piston 81. The first inner peripheral surface 80c, the second inner peripheral surface 80d, and the third inner peripheral surface 80e are lined up in this order from the piston 81 toward the cam 84 in an axial direction X of the cylinder 80. The first inner peripheral surface 80c defines a space in which the piston 81 is accommodated. The second inner peripheral surface 80d and the third inner peripheral surface 80e define a space in which the rod 82 is accommodated. An inner diameter of the second inner peripheral surface 80d is smaller than an inner diameter of the first inner peripheral surface 80c. An inner diameter of the third inner peripheral surface 80e is smaller than an inner diameter of the second inner peripheral surface 80d.

The cylinder 80 includes a first opposing surface 80f that connects the first inner peripheral surface 80c to the second inner peripheral surface 80d in a stepped manner. The first opposing surface 80f extends in a radial direction R orthogonal to the axial direction X of the cylinder 80 and is opposed to a backside of the piston 81 in the axial direction X. The cylinder 80 includes a second opposing surface 80g that connects the second inner peripheral surface 80d to the third inner peripheral surface 80e in a stepped manner. The second opposing surface 80g extends in the radial direction R orthogonal to the axial direction X of the cylinder 80.

The piston 81 is accommodated in the space defined by the first inner peripheral surface 80c in the cylinder 80. The piston 81 defines the compression chamber 91, which faces the suction port 80a and the discharge port 80b, together with the cylinder 80. The rider ring or rider rings 87 and the piston seal or piston seals 88 are externally fitted to an outer peripheral surface of the piston 81. The rider ring 87 is a slide member that prevents the axis of the piston 81 from wobbling. The piston seal 88 seals a gap between the first inner peripheral surface 80c of the cylinder 80 and the outer peripheral surface of the piston 81.

The rod 82 projects from the backside of the piston 81. The backside of the piston 81 faces away from the compression chamber 91 in the axial direction X. The rod 82 includes a first rod portion 82a and a second rod portion 82b. The first rod portion 82a projects from the backside of the piston 81 and is smaller in diameter than the piston 81. The first rod portion 82a includes a first outer peripheral surface 82c that slides on the second inner peripheral surface 80d of the cylinder 80. An outer diameter of the first rod portion 82a is substantially the same as an inner diameter of the second inner peripheral surface 80d of the cylinder 80. The second rod portion 82b projects from a backside of the first rod portion 82a and is smaller in diameter than the first rod portion 82a. To be specific, an outer peripheral surface of the rod 82 includes steps lined up in the reciprocating direction of the piston 81. The backside of the first rod portion 82a faces away from the compression chamber 91 in the axial direction X. The second opposing surface 80g of the cylinder 80 is opposed to the backside of the second rod portion 82b in the axial direction X.

The first rod portion 82a extends in the space defined by the second inner peripheral surface 80d of the cylinder 80. The first rod seal 89 is externally fitted to an outer peripheral surface of the first rod portion 82a. To be specific, the first rod seal 89 is located between the outer peripheral surface of the first rod portion 82a and the second inner peripheral surface 80d of the cylinder 80. The first rod seal 89 seals a gap between the second inner peripheral surface 80d of the cylinder 80 and the outer peripheral surface of the first rod portion 82a. The outer peripheral surface of the first rod portion 82a corresponds to the first outer peripheral surface 82c of the rod 82.

The second rod portion 82b extends in the space defined by the third inner peripheral surface 80e of the cylinder 80. The second rod seal 90 is externally fitted to an outer peripheral surface of the second rod portion 82b. To be specific, the second rod seal 90 is located between the first rod seal 89 and a below-described cam chamber 66b in the axial direction X and interposed between the outer peripheral surface of the second rod portion 82b and the third inner peripheral surface 80e of the cylinder 80. The second rod seal 90 seals a gap between the third inner peripheral surface 80e of the cylinder 80 and the outer peripheral surface of the second rod portion 82b. The outer peripheral surface of the second rod portion 82b corresponds to a second outer peripheral surface 82d of the rod 82.

The linear bushing 83 is located between the second rod seal 90 and the cam 84 in the axial direction X and supported by the cylinder 80. The second rod portion 82b is supported by the linear bushing 83 so as to be slidable in the axial direction X.

The cams 84 and the camshaft 70 are accommodated in the cam chamber 66b that is an internal space of the cam case 66. The cam 84 pushes an end surface of the rod 82 in the axial direction X to reciprocate the rod 82 in the axial direction X. The camshaft 70 is connected to the cams 84 of the two reciprocating structures 72 on an axis that is eccentric to the centers of the cams 84. When the camshaft 70 rotates, the cams 84 rotate about an axis of the camshaft 70 integrally with the camshaft 70. The camshaft 70 is rotatably supported by the cam case 66 through shaft bearings 71.

Each of the cam bearing 85 is, for example, a rolling bearing. In the present embodiment, each of the cam bearing 85 is a ball bearing. An outer peripheral surface of the cam 84 has a true circular shape. The cam bearing 85 is externally fitted to the cam 84 so as to cover the outer peripheral surface of the cam 84. The cam bearing 85 includes an inner ring 94, an outer ring 95, and balls 96. Each of the inner ring 94 and the outer ring 95 has a true circular shape. The inner ring 94 is fitted to the outer peripheral surface of the cam 84. The balls 96 are located between the inner ring 94 and the outer ring 95. The balls 96 are held at predetermined positions by a retainer, but the retainer is not illustrated.

The outer ring 95 is rotatable relative to the inner ring 94 through the balls 96. To be specific, the outer ring 95 is a ring that covers the outer peripheral surface of the cam 84 and is rotatable relative to the cam 84. The outer ring 95 contacts an end surface 82e of the rod 82 in the axial direction X. The end surface 82e of the rod 82 is a surface that faces away from the compression chamber 91 in the axial direction X. The cam 84 pushes the end surface 82e of the rod 82 in the axial direction X through the cam bearing 85. The spring 86 biases the rod 82 in a direction in which the rod 82 moves toward the cam 84.

Since the outer ring 95 rotates relative to the cam 84 as above, sliding resistance received by the cam 84 from the rod 82 is reduced. Moreover, force applied from the cam 84 to the rod 82 in the radial direction R is reduced, and the sliding resistance between the piston 81 and the cylinder 80 is also reduced.

The compression chamber 91 is connected to the fuel tanks 11 to 14. Therefore, the pressure in the cam chamber 66b is set to be lower than the internal pressure of the compression chamber 91 even in a state where the piston 81 has moved to a bottom dead center. In the present embodiment, the cam case 66 includes a communication hole that communicates with a space outside the cam case 6. To be specific, the cam chamber 66b is open to the atmosphere. Therefore, force that pushes the piston 81 toward the cam 84 can be generated by a pressure difference between the compression chamber 91 and the cam chamber 66b. Thus, the spring 86 having a low elastic modulus can be used.

The cams 84 of the two reciprocating structures 72 have respective phases that are equally shifted from each other. To be specific, when the piston 81 of one of the reciprocating structures 72 is at a top dead center, the piston 81 of the other reciprocating structure 72 is at the bottom dead center. When one of the reciprocating structures 72 needs to rotate the cam 84 so as to generate force that compresses the fuel gas in the compression chamber 91, the pressure of the fuel gas which has flowed into the compression chamber 91 of the other reciprocating structure 72 moves the piston 81 backward to rotate the corresponding cam 84. To be specific, the operation of one of the reciprocating structures 72 is assisted by the operation of the other reciprocating structure 72. Therefore, the driving force to be generated by the electric motor 61 (see FIG. 2) that rotates the camshaft 70 can be reduced, and the spring 86 can be reduced in weight and size.

Two gaskets G are sandwiched between the cylinder head 64 and the cylinder block 65 so as to surround respective internal spaces of the cylinders 80 of the two reciprocating structures 72. Similarly, another two gaskets G are sandwiched between the cylinder block 65 and the cam case 66 so as to surround the respective internal spaces of the cylinders 80 of the two reciprocating structures 72. Lubricating oil may be stored in the cam chamber 66b of the cam case 66. Thus, the shaft bearings 71 and the cam bearings 85 are lubricated with the oil.

The recompression chamber 92 is located between the piston 81 and the first rod seal 89 in the axial direction X. The recompression chamber 92 is defined by the outer peripheral surface of the first rod portion 82a of the rod 82, the first inner peripheral surface 80c of the cylinder 80, the backside of the piston 81, and the first opposing surface 80f of the cylinder 80. When viewed in the axial direction X, the recompression chamber 92 has an annular shape. When the piston 81 moves backward so as to approach the cam chamber 66b, a distance between the backside of the piston 81 and the first opposing surface 80f of the cylinder 80 decreases. Therefore, the volume of the recompression chamber 92 is reduced by the backward movement of the piston 81.

The cylinder 80 includes an outflow port 80h that is in fluid communication with the recompression chamber 92. A check valve 99 that communicates with the outflow port 80h is attached to the cylinder 80. The check valve 99 projects from the cylinder 80 to the outside. It is preferable that the heat sink 67 project in at least a direction in which the check valve 99 projects. Thus, regarding the outer shape of the compressor 60, the amount of projection of the check valve 99 projecting from the cylinder 80 including the heat sink 67 is suppressed.

The check valve 99 allows the flow from the recompression chamber 92 through the outflow port 80h to the outside of the recompression chamber 92 and blocks the flow from the outside of the recompression chamber 92 through the outflow port 80h to the recompression chamber 92.

When the fuel gas of the compression chamber 91 has leaked into the recompression chamber 92 across the piston seals 88, the leaked fuel gas is recompressed in the recompression chamber 92 by the backward movement of the piston 81. This recompressed leak gas is discharged from the outflow port 80h of the cylinder 80 through the check valve 99 to the outside. The fuel gas discharged from the outflow port 80h is supplied to the suction port 80a again through a return passage 62c (see FIG. 2) and an inlet passage 62a (see FIG. 2).

The outflow port 80h is located at a position offset from the recompression chamber 92 in a direction, in which the suction port 80a is offset from the center of the compression chamber 91 in the radial direction R of the cylinder 80. Therefore, the check valve 97 located at the suction port 80a and the check valve 99 located at the outflow port 80h can be made close to each other, and the length of the return passage 62c required to merge with the inlet passage 62a can be reduced.

The re-leak chamber 93 is located between the first rod seal 89 and the second rod seal 90 in the axial direction X. The re-leak chamber 93 is defined by the outer peripheral surface of the second rod portion 82b of the rod 82, the second inner peripheral surface 80d of the cylinder 80, the backside of the first rod portion 82a of the rod 82, and the second opposing surface 80g of the cylinder 80. The re-leak chamber 93 has an annular shape when viewed in the axial direction X. When the rod 82 moves backward so as to approach the cam chamber 66b, a distance between the backside of the first rod portion 82a and the second opposing surface 80g of the cylinder 80 decreases. Therefore, the volume of the re-leak chamber 93 is reduced by the backward movement of the rod 82. To be specific, the first rod portion 82a serves as a piston that reduces the volume of the re-leak chamber 93.

The cylinder 80 includes an exhaust port 80i that is in fluid communication with the re-leak chamber 93. The exhaust port 80i is connected to the leak port 6c (see FIG. 2) of the compressor assembly 6. When the fuel gas in the recompression chamber 92 has leaked into the re-leak chamber 93 across the first rod seals 89, the leaked fuel gas is discharged from the re-leak chamber 93 through the exhaust port 80i to the outside by the backward movement of the rod 82. Therefore, the leaked fuel gas is prevented from flowing to the cam chamber 66b. The fuel gas discharged from the exhaust port 80i is supplied to the intake passage 47 through a discharge passage 62d (see FIG. 2) and the blow-by gas passage 49 (see FIG. 1). Thus, the leaked fuel gas can contribute to the combustion in the internal combustion engine E by being mixed with air.

The re-leak chamber 93 communicates with the intake passage 47. Therefore, even during the stroke in which the piston 81 moves from the top dead center to the bottom dead center, the internal pressure of the re-leak chamber 93 is set to be lower than the internal pressure of the compression chamber 91. Thus, the force that presses the rod 82 against the cam 84 can be further increased, and therefore, the spring 86 having low elastic modulus can be used.

The re-leak chamber 93 communicates with the intake passage 47 in which negative pressure is generated by the intake stroke of the internal combustion engine E. Therefore, during the intake stroke of the internal combustion engine E, the internal pressure of the re-leak chamber 93 is set to be lower than the internal pressure of the cam chamber 66b. Thus, the leak of the fuel gas from the re-leak chamber 93 to the cam chamber 66b is suitably prevented.

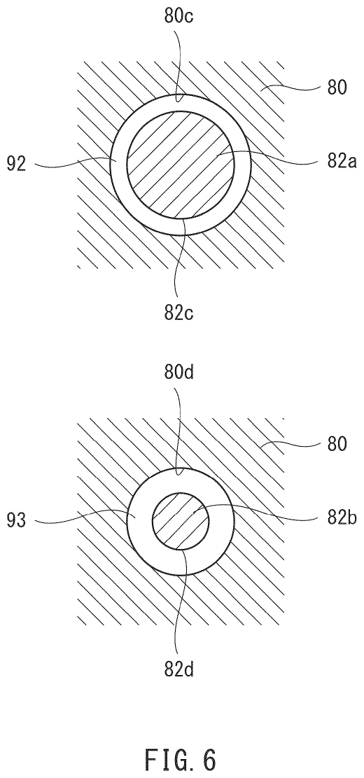

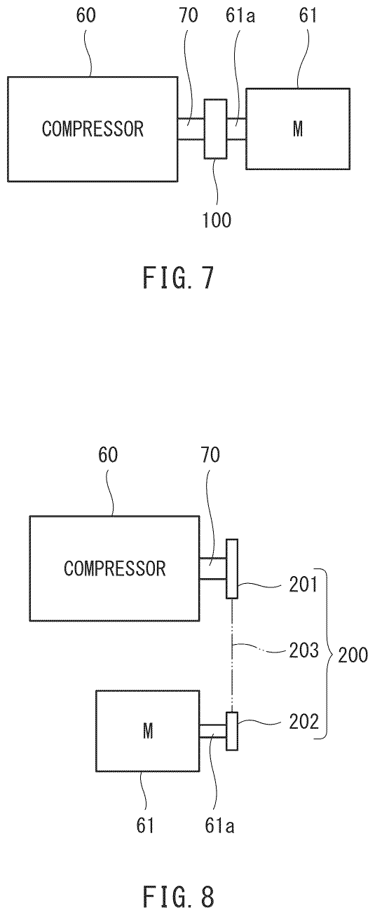

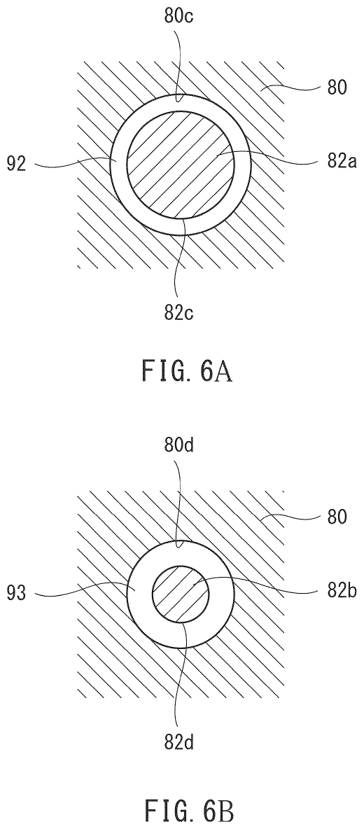

As shown in FIG. 6, a distance in the radial direction R from the first inner peripheral surface 80c of the cylinder 80 to the first outer peripheral surface 82c of the first rod portion 82a in the recompression chamber 92 is shorter than a distance in the radial direction R from the second inner peripheral surface 80d of the cylinder 80 to the second peripheral surface 82d of the second rod portion 82b in the re-leak chamber 93. In the present embodiment, regarding a section of the compressor 60 taken along the radial direction R, the sectional area of the recompression chamber 92 is substantially the same as the sectional area of the re-leak chamber 93. However, the sectional area of the recompression chamber 92 and the sectional area of the re-leak chamber 93 are not limited to this.

Referring back to FIG. 2, the passage group 62 of the compressor assembly 6 includes the inlet passage 62a, an outlet passage 62b, the return passage 62c, and the discharge passage 62d. The inlet passage 62a connects the inlet port 6a of the compressor assembly 6 to the suction ports 80a of the compressor 60 through the check valves 97. The outlet passage 62b connects the discharge ports 80b of the compressor 60 to the outlet port 6b of the compressor assembly 6 through the check valves 98. The return passage 62c connects the outflow ports 80h of the recompression chambers 92 of the compressor 60 to the inlet passage 62a.

The fuel gas recompressed in the recompression chamber 92 of the compressor 60 is supplied to the suction port 80a of the compressor 60 again through the check valve 99 and the return passage 62c. Therefore, the fuel gas which has leaked from the compression chamber 91 and has been recompressed in the recompression chamber 92 is supplied to the fuel injector 45 of the internal combustion engine E. The discharge passage 62d connects the exhaust ports 80i of the re-leak chambers 93 of the compressor 60 to the leak port 6c of the compressor assembly 6. Therefore, the fuel gas which has leaked from the compression chamber 91 and the recompression chamber 92 and has reached the re-leak chamber 93 is utilized for the combustion as the intake gas in the internal combustion engine E.

As shown in FIGS. 3 to 5, in the present embodiment, when viewed in the axial direction X of the cylinder 80, the through bolts B are located around the reciprocating structures 72. Thus, even when resistance force to the compressive force is generated in the compressor 60, the fastening of the cylinder head 64, the cylinder block 65, and the cam case 66 is firmly maintained by the through bolts B. Specifically, the through bolts B are located so as to be lined up in the axial direction of the camshaft 70. The through bolts B are located so as to be lined up also in a direction orthogonal to both of the axial direction of the camshaft 70 and the axial direction X of the cylinder 80.

Moreover, since the through bolts B are located so as to be lined up in directions in which the check valves 97 and/or 98 are lined up, the through bolts B can be located so as to avoid interference with the check valves 97 and 98. Moreover, since the through bolts B are offset from the suction ports 80a, the discharge ports 80b, and the exhaust ports 80i in the axial direction of the camshaft 70, the through bolts B can be prevented from interfering with the suction ports 80a, the discharge ports 80b, and the exhaust ports 80i. In other words, it is preferable that the suction port 80a, the discharge port 80b, and the exhaust port 80i in one particular reciprocating structure 72 be located along a virtual plane orthogonal to the camshaft 70.

FIG. 7 is a block diagram showing an example of the arrangement of a speed reducer 100 and the electric motor 61. As shown in FIG. 7, the driving force of the electric motor 61 may be input to the camshaft 70 of the compressor 60 through the speed reducer 100. In this case, the electric motor 61 can be reduced in size. The electric motor 61 may be lined up with the compressor 60 in a direction in which the camshaft 70 of the compressor 60 extends. Specifically, the camshaft 70 of the compressor 60 and a driving shaft 61a of the electric motor 61 may be located coaxially with each other. The structure of the speed reducer 100 is not especially limited and may include, for example, a planetary gear structure.

FIG. 8 is a block diagram showing another example of the arrangement of a speed reducer 200 and the electric motor 61. As shown in FIG. 8, the driving force of the electric motor 61 may be input to the camshaft 70 of the compressor 60 through the speed reducer 200. The electric motor 61 may be lined up with the compressor 60 in a direction orthogonal to a direction in which the camshaft 70 of the compressor 60 extends. Specifically, the camshaft 70 of the compressor 60 and the driving shaft 61a of the electric motor 61 may be located in parallel with each other. The structure of the speed reducer 200 is not especially limited and may include, for example, a pulley-belt structure or a chain-sprocket structure.

According to the above-described configuration, since the piston 81 is caused to reciprocate by the cam 84, the compressor 60 can be downsized compared to a reciprocating compressor in which a piston is caused to reciprocate by a crankshaft and a connecting rod. For example, when the piston is located at a position that is not the top dead center or the bottom dead center, the connecting rod is inclined relative to a piston reciprocating direction to project in a direction orthogonal to the piston reciprocating direction, and this increases the size of the case of the compressor. On the other hand, according to the present embodiment, since the extending direction of the rod 82 is maintained in alignment with the reciprocating direction of the piston 81, the case of the compressor 50 can be reduced in size. Therefore, the amount of fuel gas that can be supplied to the internal combustion engine E can be increased while preventing the increase in the size of the system 1 due to the reduction in the size of the compressor 60.

The technology of the present disclosure is not limited to the above-described embodiment. For example, the present system is suitably applicable to a movable body that is required to be reduced in size. However, the present disclosure is not limited to this, and the present system may be mounted on a non-movable body. For example, the internal combustion engine system 1 may be used as the driving source of a power generator that can be transported. In this case, the internal combustion engine system 1 serves as a driving source that rotates a generator for electric power generation. The present system may also be applied to a fixed object, such as fixed equipment. In the above embodiment, the number of fuel tanks 11 to 14 is plural, but the number of fuel tanks may be only one. When the fuel tank is detachable, the internal combustion engine system 1 to be sold may not include the fuel tank, for example.

The arrangement type of the cylinders 80 does not have to be a parallel type and may be a horizontally opposed type, a V type, or the like. The direction of each cylinder 80 does not have to be a vertical direction and may be, for example, a horizontal direction. The configurations of the passages and the valve system in the embodiment are merely examples. The spring 86 may be omitted. The number of cylinders of the compressor assembly 6 may be one or may be three or more. A destination to which the outflow port 80h of the recompression chamber 92 is connected does not have to be the suction port 80a and may be a portion downstream of the discharge port 80b, which is the charge passage 5 or the sub-passage 7. The first opposing surface 80f and the second opposing surface 80g may be inclined relative to the radial direction R.

As described above, the outer ring 95 covering the cam 84 is rotatable relative to the cam 84 through the balls 96. However, the outer ring 95 may be rotatable through cylindrical rollers or tapered rollers instead of the balls 96. As above, it is preferable to use the rolling bearing. The cam bearing 85 does not have to be the rolling bearing and may be a sliding bearing or a fluid bearing. When the cam bearing 85 is the sliding bearing or the fluid bearing, a cylindrical body externally fitted to the cam 84 is a ring that covers the outer peripheral surface of the cam 84 and is rotatable relative to the cam 84.

The recompression chambers 92 may be located. As described above, regarding the section of the compressor 60 taken along the radial direction R, the sectional area of the recompression chamber 92 is smaller than the sectional area of the re-leak chamber 93. However, the sectional area of the recompression chamber 92 is not limited to this. The sectional area of the recompression chamber 92 may be the same as the sectional area of the re-leak chamber 93 or may be larger than the sectional area of the re-leak chamber 93. One or both of the recompression chamber 92 and the re-leak chamber 93 may be omitted.

When the compressor 60 includes the reciprocating structures 72, the reciprocating structures 72 may be lined up along the axis of the camshaft 70 or may be lined up around the axis of the camshaft 70. When the reciprocating structures 72 are lined up along or around the camshaft 70, the camshaft 70 can be shared among the reciprocating structures 72, and therefore, the compressor can be easily made compact.

It is preferable that when the compressor includes the reciprocating structures 72, the directions of eccentricity of the cams 84 corresponding to the respective reciprocating structures 72 be different from each other. For example, it is preferable that when the number of reciprocating structures 72 is N, the phases of the cams 84 be shifted around the axis of the camshaft 70 by an angle obtained by dividing 360° by N (i.e., 360°/N). Thus, the change in the rotational resistance of the camshaft 70 due to the change in the rotation angle of the camshaft 70 can be suppressed.

The compressor 60 may include a relief valve that prevents the pressure in the cam chamber 66b from approaching the internal pressure of the compression chamber 91 while maintaining a state where the pressure in the cam chamber 66b is higher than atmospheric pressure. By increasing the pressure in the cam chamber 66b, the leak of the fuel gas to the cam chamber 66b is easily prevented.

The foregoing has described the embodiment as an example of the technology disclosed in the present application. However, the technology in the present disclosure is not limited to this and is applicable to embodiments in which modifications, replacements, additions, omissions, and the like have been suitably made. Moreover, a new embodiment may be prepared by combining the components described in the above embodiment. Some components in an embodiment may be separated from the other components in the embodiment and arbitrarily extracted. Furthermore, the components shown in the attached drawings and the detailed explanations include not only components essential to solve the problems but also components for exemplifying the above technology and not essential to solve the problems.

The following aspects disclose preferred embodiments.

### FIRST ASPECT

An internal combustion engine system including:
a fuel storing source including at least one fuel tank storing a fuel gas in a compressed state;
a fuel gas passage that connects the fuel storing source to an internal combustion engine; and
a compressor that pressurizes the fuel gas in the fuel gas passage, wherein:
   the compressor includes at least one reciprocating structure; and
the reciprocating structure includes
   a cylinder including a suction port and a discharge port,
   a piston accommodated in the cylinder and defining a compression chamber facing the suction port and the discharge port,
   a rod projecting from the piston, and
   a cam that reciprocates the rod.

According to this configuration, even when the pressure of the fuel gas in the fuel storing source drops, the fuel gas can be pressurized by the compressor, and the pressurized fuel gas can be supplied to the internal combustion engine. Therefore, the amount of fuel gas that can be supplied to the internal combustion engine can be increased without increasing the size of the fuel storing source. Moreover, since the compressor reciprocates the piston by the cam, the compressor can be downsized compared to a reciprocating compressor that reciprocates a piston by a camshaft and a connecting rod. Therefore, the amount of fuel gas that can be supplied to the internal combustion engine can be increased while preventing the increase in the size of the system due to the reduction in the size of the compressor.

### SECOND ASPECT

The internal combustion engine system according to the first aspect, wherein:
the reciprocating structure further includes
   a first rod seal located between an outer peripheral surface of the rod and an inner peripheral surface of the cylinder and
   a recompression chamber located between the piston and the first rod seal in an axial direction of the cylinder;
the recompression chamber is defined by the outer peripheral surface of the rod and the inner peripheral surface of the cylinder;
a volume of the recompression chamber decreases by backward movement of the piston; and
the cylinder includes an outflow port that is in fluid communication with the recompression chamber.

According to this configuration, when the fuel gas in the compression chamber leaks across the piston to a space where the rod is located, the leaked fuel gas is recompressed in the recompression chamber by the backward movement of the piston. The recompressed leak gas is discharged through the outflow port of the cylinder to the outside. Therefore, the leaked fuel gas can be prevented from accumulating in the cylinder.

### THIRD ASPECT

The internal combustion engine system according to the second aspect, wherein:
the reciprocating structure further includes a check valve that allows a flow from the recompression chamber through the outflow port to an outside of the recompression chamber and blocks a flow from the outside of the recompression chamber through the outflow port to the recompression chamber; and
the outflow port is in fluid connection with a passage that is in fluid connection with the internal combustion engine through the check valve.

According to this configuration, the leak fuel gas recompressed in the recompression chamber can be utilized for supply to the internal combustion engine.

### FOURTH ASPECT

The internal combustion engine system according to the second or third aspect, wherein:
the inner peripheral surface of the cylinder includes
   a first inner peripheral surface defining a space in which the piston is accommodated and
   a second inner peripheral surface defining a space in which the rod is accommodated;
an inner diameter of the second inner peripheral surface is smaller than an inner diameter of the first inner peripheral surface;
the cylinder further includes an opposing surface that extends in a radial direction, connects the first inner peripheral surface to the second inner peripheral surface, and is opposed to the piston in the axial direction; and
the recompression chamber is defined between the piston and the opposing surface of the cylinder.

According to this configuration, when the fuel gas flows from the suction port of the cylinder into the compression chamber, and the piston moves backward, a distance between the piston and the opposing surface of the cylinder in the axial direction of the cylinder decreases. Therefore, the leak fuel gas having flowed into the recompression chamber across the piston can be suitably compressed by the backward movement of the piston.

### FIFTH ASPECT

The internal combustion engine system according to any one of the second to fourth aspects, wherein:
the compressor further includes a cam case defining a cam chamber in which the cam is accommodated;
the reciprocating structure further includes
   a second rod seal located between the first rod seal and the cam chamber in the axial direction of the cylinder and interposed between the outer peripheral surface of the rod and the inner peripheral surface of the cylinder and
   a re-leak chamber located between the first rod seal and the second rod seal in the axial direction of the cylinder;
the re-leak chamber is defined by the outer peripheral surface of the rod and the inner peripheral surface of the cylinder;
a volume of the re-leak chamber decreases by backward movement of the rod; and
the cylinder includes an exhaust port that is in fluid communication with the re-leak chamber.

According to this configuration, when the fuel gas which has leaked from the compression chamber to the recompression chamber across the piston further leaks across the first rod seal, the leaked fuel gas can be pressurized in the re-leak chamber by the backward movement of the rod and discharged through the exhaust port. Therefore, the leaked fuel can be further suitably prevented from flowing to the cam chamber.

### SIXTH ASPECT

The internal combustion engine system according to the fifth aspect, wherein:
the outflow port communicating with the recompression chamber is in fluid connection with a passage through which the fuel gas is supplied to a fuel injector of the internal combustion engine; and
the exhaust port of the re-leak chamber is in fluid connection with an intake passage that is in fluid connection with the internal combustion engine.

According to this configuration, the leaked fuel gas is easily utilized for the combustion of the internal combustion engine.

### SEVENTH ASPECT

The internal combustion engine system according to any one of the first to sixth aspects, wherein:
the compressor further includes a cam chamber in which the cam is accommodated; and
during a stroke in which the piston moves from a top dead center to a bottom dead center, internal pressure of the cam chamber is set to be lower than internal pressure of the compression chamber.

According to this configuration, since the force that pushes the rod toward the cam is generated by the pressure difference, a contact state between the cam and the rod is easily maintained.

### EIGHTH ASPECT

The internal combustion engine system according to any one of the first to seventh aspects, wherein:
the compressor further includes a camshaft that rotates the cam;
the reciprocating structure further includes a ring that covers an outer peripheral surface of the cam and is rotatable relative to the cam;
the outer peripheral surface of the cam includes a true circular shape;
the camshaft is eccentrically connected to the cam; and
the cam pushes the rod through the ring.

According to this configuration, since the ring rotates relative to the cam, the sliding resistance received by the cam from the rod decreases. Thus, energy required to drive the compressor can be reduced. Moreover, force applied from the cam to the rod in the radial direction orthogonal to the axial direction of the cylinder can be reduced. Therefore, force applied from the piston to the cylinder in the radial direction decreases, and this can reduce the sliding resistance between the piston and the cylinder.

### NINTH ASPECT

The internal combustion engine system according to any one of the first to eighth aspects, wherein
the reciprocating structure further includes
   a check valve that allows a flow from the charge passage through the suction port to the compression chamber and blocks a flow from the compression chamber through the suction port to the charge passage and
   a check valve that allows a flow from the compression chamber through the discharge port to the charge passage and blocks a flow from the charge passage through the discharge port to the compression chamber.

According to this configuration, the suction of the fuel gas into the compression chamber and the discharge of the fuel gas from the compression chamber can be smoothly performed without special control.

### TENTH ASPECT

The internal combustion engine system according to any one of the first to ninth aspects, wherein:
the at least one reciprocating structure includes reciprocating structures; and
the cams of the reciprocating structures have respective phases that are equally shifted from each other.

According to this configuration, when one of the reciprocating structures needs to rotate the cam so as to generate force that compresses the fuel gas in the compression chamber, the pressure of the fuel gas which has flowed into the compression chamber of another reciprocating structure moves the piston backward to rotate the corresponding cam. To be specific, the operation of one of the reciprocating structures is assisted by the operation of another reciprocating structure. Therefore, the maximum value of the driving force required to drive the camshaft can be prevented from increasing.

### ELEVENTH ASPECT

The internal combustion engine system according to any one of the first to tenth aspects, further including a cooler that cools the fuel gas discharged from the discharge port of the compressor.

According to this configuration, the volume of the fuel gas can be reduced by the cooling, and the filling amount of fuel gas supplied to the internal combustion engine, i.e., the density of the fuel gas can be increased.

### TWELFTH ASPECT

A compressor including:
a cylinder including a suction port and a discharge port;
a piston accommodated in the cylinder and defining a compression chamber facing the suction port and the discharge port;
a rod projecting from the piston;
a cam that reciprocates the rod;
a camshaft that rotates the cam; and
a ring that covers an outer peripheral surface of the cam and is rotatable relative to the cam, wherein:
   the outer peripheral surface of the cam includes a true circular shape;
the camshaft is eccentrically connected to the cam; and
the cam pushes the rod through the ring.

According to this configuration, since the compressor reciprocates the piston by the cam, the compressor can be downsized compared to a reciprocating compressor that reciprocates a piston by a camshaft and a connecting rod.

### THIRTEENTH ASPECT

A compressor including:
a cylinder including a suction port and a discharge port;
a piston accommodated in the cylinder and defining a compression chamber facing the suction port and the discharge port;
a rod projecting from the piston;
a first rod seal located between an outer peripheral surface of the rod and an inner peripheral surface of the cylinder; and
a recompression chamber located between the piston and the first rod seal in an axial direction of the cylinder, wherein:
the recompression chamber is defined by the outer peripheral surface of the rod and the inner peripheral surface of the cylinder;
a volume of the recompression chamber decreases by backward movement of the piston; and
the cylinder includes an outflow port that is in fluid communication with the recompression chamber.

According to this configuration, when the fuel gas in the compression chamber leaks across the piston into a space where the rod is located, the leaked fuel gas is recompressed in the recompression chamber by the backward movement of the piston. The recompressed leak gas is discharged through the outflow port of the cylinder to the outside. Therefore, the leaked fuel gas can be prevented from accumulating in the cylinder.

### REFERENCE SIGNS LIST

1 internal combustion engine system
2 fuel storing source
11 to 14 fuel tank
28 cooler
45 fuel injector
47 intake passage
60 compressor
66 cam case
66b cam chamber
70 camshaft
72 reciprocating structure
80 cylinder
80a suction port
80b discharge port
80c first inner peripheral surface
80d second inner peripheral surface
80e third inner peripheral surface
80f first opposing surface
80h outflow port
80i exhaust port
81 piston
82 rod
82a first rod portion
82c first outer peripheral surface
82b second rod portion
82d second outer peripheral surface
84 cam
89 first rod seal
91 compression chamber
92 recompression chamber
93 re-leak chamber
95 outer ring (ring)
97 to 99 check valve
E internal combustion engine
R radial direction
X axial direction

1. An internal combustion engine system comprising:
a fuel gas passage that connects a fuel storing source to an internal combustion engine, the fuel storing source storing a fuel gas in a compressed state; and
a compressor that pressurizes the fuel gas in the fuel gas passage, wherein:
the compressor includes at least one reciprocating structure; and
the reciprocating structure includes
a cylinder including a suction port and a discharge port,
a piston accommodated in the cylinder and defining a compression chamber facing the suction port and the discharge port,
a rod projecting from the piston, and
a cam that reciprocates the rod.

2. The internal combustion engine system according to claim 1, wherein:
the reciprocating structure further includes
a first rod seal located between an outer peripheral surface of the rod and an inner peripheral surface of the cylinder and
a recompression chamber located between the piston and the first rod seal in an axial direction of the cylinder;
the recompression chamber is defined by the outer peripheral surface of the rod and the inner peripheral surface of the cylinder;
a volume of the recompression chamber decreases by backward movement of the piston; and
the cylinder includes an outflow port that is in fluid communication with the recompression chamber.

3. The internal combustion engine system according to claim 2, wherein:
the reciprocating structure further includes a check valve that allows a flow from the recompression chamber through the outflow port to an outside of the recompression chamber and blocks a flow from the outside of the recompression chamber through the outflow port to the recompression chamber; and
the outflow port is in fluid connection with a passage that is in fluid connection with the internal combustion engine through the check valve.

4. The internal combustion engine system according to claim 2, wherein:
the inner peripheral surface of the cylinder includes
a first inner peripheral surface defining a space in which the piston is accommodated and
a second inner peripheral surface defining a space in which the rod is accommodated;
an inner diameter of the second inner peripheral surface is smaller than an inner diameter of the first inner peripheral surface;
the cylinder further includes an opposing surface that extends in a radial direction, connects the first inner peripheral surface to the second inner peripheral surface, and is opposed to the piston in the axial direction; and
the recompression chamber is defined between the piston and the opposing surface of the cylinder.

5. The internal combustion engine system according to claim 2, wherein:
the compressor further includes a cam case defining a cam chamber in which the cam is accommodated;
the reciprocating structure further includes
a second rod seal located between the first rod seal and the cam chamber in the axial direction of the cylinder and interposed between the outer peripheral surface of the rod and the inner peripheral surface of the cylinder and
a re-leak chamber located between the first rod seal and the second rod seal in the axial direction of the cylinder;
the re-leak chamber is defined by the outer peripheral surface of the rod and the inner peripheral surface of the cylinder;
a volume of the re-leak chamber decreases by backward movement of the rod; and
the cylinder includes an exhaust port that is in fluid communication with the re-leak chamber.

6. The internal combustion engine system according to claim 5, wherein:
the outflow port communicating with the recompression chamber is in fluid connection with a passage through which the fuel gas is supplied to a fuel injector of the internal combustion engine; and
the exhaust port of the re-leak chamber is in fluid connection with an intake passage that is in fluid connection with the internal combustion engine.

7. The internal combustion engine system according to claim 1, wherein:
the compressor further includes a cam chamber in which the cam is accommodated; and
during a stroke in which the piston moves from a top dead center to a bottom dead center, internal pressure of the cam chamber is set to be lower than internal pressure of the compression chamber.

8. The internal combustion engine system according to claim 1, wherein:
the compressor further includes a camshaft that rotates the cam;
the reciprocating structure further includes a ring that covers an outer peripheral surface of the cam and is rotatable relative to the cam;
the outer peripheral surface of the cam includes a true circular shape;
the camshaft is eccentrically connected to the cam; and
the cam pushes the rod through the ring.

9. The internal combustion engine system according to claim 1, wherein
the reciprocating structure further includes
a check valve that allows a flow from the charge passage through the suction port to the compression chamber and blocks a flow from the compression chamber through the suction port to the charge passage and
a check valve that allows a flow from the compression chamber through the discharge port to the charge passage and blocks a flow from the charge passage through the discharge port to the compression chamber.

10. The internal combustion engine system according to claim 1, wherein:
the at least one reciprocating structure comprises reciprocating structures; and
the cams of the reciprocating structures have respective phases that are equally shifted from each other.

11. The internal combustion engine system according to claim 1, further comprising a cooler that cools the fuel gas discharged from the discharge port of the compressor.

12. A compressor comprising:
a cylinder including a suction port and a discharge port;
a piston accommodated in the cylinder and defining a compression chamber facing the suction port and the discharge port;
a rod projecting from the piston;
a cam that reciprocates the rod;
a camshaft that rotates the cam; and
a ring that covers an outer peripheral surface of the cam and is rotatable relative to the cam, wherein:
the outer peripheral surface of the cam includes a true circular shape;
the camshaft is eccentrically connected to the cam; and
the cam pushes the rod through the ring.

13. A compressor comprising:
a cylinder including a suction port and a discharge port;
a piston accommodated in the cylinder and defining a compression chamber facing the suction port and the discharge port;
a rod projecting from the piston;
a first rod seal located between an outer peripheral surface of the rod and an inner peripheral surface of the cylinder; and
a recompression chamber located between the piston and the first rod seal in an axial direction of the cylinder, wherein:
the recompression chamber is defined by the outer peripheral surface of the rod and the inner peripheral surface of the cylinder;
a volume of the recompression chamber decreases by backward movement of the piston; and
the cylinder includes an outflow port that is in fluid communication with the recompression chamber.
